(19) United States
(12) Patent Application Publication
(10) Pub. No.: US 2021/0166312 A1
(43) Pub. Date: Jun. 3, 2021

(54) Systems and Methods for Autonomous Portfolio Management and Funding Using Smart Contracts

(71) Applicant: JPMorgan Chase Bank, N.A., New York, NY (US)

(72) Inventors: Subroto Dakshi, Mumbai (IN); Nicholas M. Lore, Pearl River, NY (US); Ankur Sambhar, Thane West (IN)

(21) Appl. No.: 15/332,025

(22) Filed: Oct. 24, 2016

(51) Int. Cl. G06Q 40/04; G06Q 40/06

(52) U.S. Cl. CPC G06Q 40/04; G06Q 40/06

(57) ABSTRACT

Systems and methods for autonomous portfolio management and funding using smart contracts are disclosed. In one embodiment, a method for autonomous portfolio management may include (1) a portfolio management system comprising a computer processor generating a portfolio template for an investment portfolio, the portfolio template comprising at least one investment vehicle, an identification of a least one investor, and an identification of a funding account; (2) the portfolio management system receiving at least one portfolio rule specifying a condition and an action to take with the investment vehicle in response to the condition; and (3) the portfolio management system writing the portfolio template to a dependent ledger as a smart contract.

### BACKGROUND OF THE INVENTION

### 1. Field of the Invention

The present disclosure generally relates to systems and methods for autonomous portfolio management and funding using smart contracts.

### 2. Description of The Related Art

Investors generally either manage their own portfolios or hire a portfolio manager to do the same. In first case, the investors make the decisions based on their own research, which may not be as extensive as done by a professional. Even when user hires a professional to manage the portfolio, the decisions are generally based on the portfolio manager's research or thought process. It may be the case that the portfolio manager has overlooked a particular aspect which could impact the trading decisions adversely, such as political instability, natural disaster, potential company acquisition/merger, officer exits, etc. Also, although there are multiple sources in the market that provide analysis for a given instrument, the correct one is not easy to pick. There are also chances that the humans can take wrong decisions under pressure.

### SUMMARY OF THE INVENTION

Systems and methods for autonomous portfolio management and funding using smart contracts are disclosed. In one embodiment, a method for autonomous portfolio management may include (1) a portfolio management system comprising a computer processor generating a portfolio template for an investment portfolio, the portfolio template comprising at least one investment vehicle, an identification of at least one investor, and an identification of a funding account; (2) the portfolio management system receiving at least one portfolio rule specifying a condition and an action to take with the investment vehicle in response to the condition; and (3) the portfolio management system writing the portfolio template to a dependent ledger as a smart contract.

In one embodiment, the portfolio template may also include a voting policy for managing the action for the at least one portfolio rule.

In one embodiment, the portfolio template may also include a voting policy for defining the portfolio rules.

In one embodiment, the method may also include the portfolio management system monitoring at least one environment for the condition; the portfolio management system writing the condition that was monitored to the ledger; and the portfolio management system executing the smart contract comprising executing the action.

In one embodiment, the environment may be an economic environment, a political environment, etc.

In one embodiment, the action may be to fund the portfolio.

In one embodiment, the portfolio template may also include sign-on information for the funding account, and the method may further include the portfolio management system accessing the funding account using the sign-on information; the portfolio management system transferring funds from the funding account to the portfolio; and the portfolio management system writing the transfer of funds to the dependent leger.

In one embodiment, the sign-on information may be associated with a plurality of funding accounts.

In one embodiment, the sign on may transfer funds from one funding account to another funding account. The funding accounts may be within the same, or in different, entities.

In one embodiment, executing the action may include the portfolio management system executing a trade involving the investment vehicle using a trading system.

According to another embodiment, a system for autonomous portfolio management may include a plurality of inputs comprising market data and research data; a dependent ledger; and a portfolio management platform. The portfolio management platform may include at least one computer processor; a portfolio template generator that generates a portfolio template comprising at least one investment vehicle, an identification of at least one investor, an identification of a funding account, and at least one portfolio rule specifying a condition and an action to take with the investment vehicle in response to the condition; a smart contract generator that writes the portfolio template to the distributed ledger; a decision making engine that monitors the inputs for the condition and executes the smart contract comprising executing the action; and a ledger transaction executor that writes the action to the distributed ledger.

In one embodiment, the portfolio template may also include a voting policy for managing the action for the at least one portfolio rule.

In one embodiment, the decision making engine may write the monitored condition to the ledger.

In one embodiment, the environment may be an economic environment, a political environment, etc.

In one embodiment, the action may be funding the portfolio.

In one embodiment, the system may also include a plurality of bank systems comprising at least one trading system and a sign-on system. The sign-on system may access the funding account using sign-on information that may be part of the portfolio template. The portfolio management platform may transfer funds from the funding account to the portfolio. The ledger execution executor may write the transfer of funds to the dependent leger.

The system of claim 16, wherein the sign-on information may be associated with a plurality of funding accounts.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for autonomous portfolio management and funding using smart contracts according to one embodiment;

FIG. 2 depicts a method for autonomous portfolio management and funding using smart contracts according to one embodiment;

FIG. 3 depicts a method for autonomous portfolio management using smart contracts according to one embodiment;

FIG. 4 depicts method for accessing a plurality of accounts according to one embodiment.

FIG. 5 depicts method for conducting a sign-on transaction according to one embodiment.

### DETAILED DESCRIPTION OF PREFERRED EMBODIMENTS

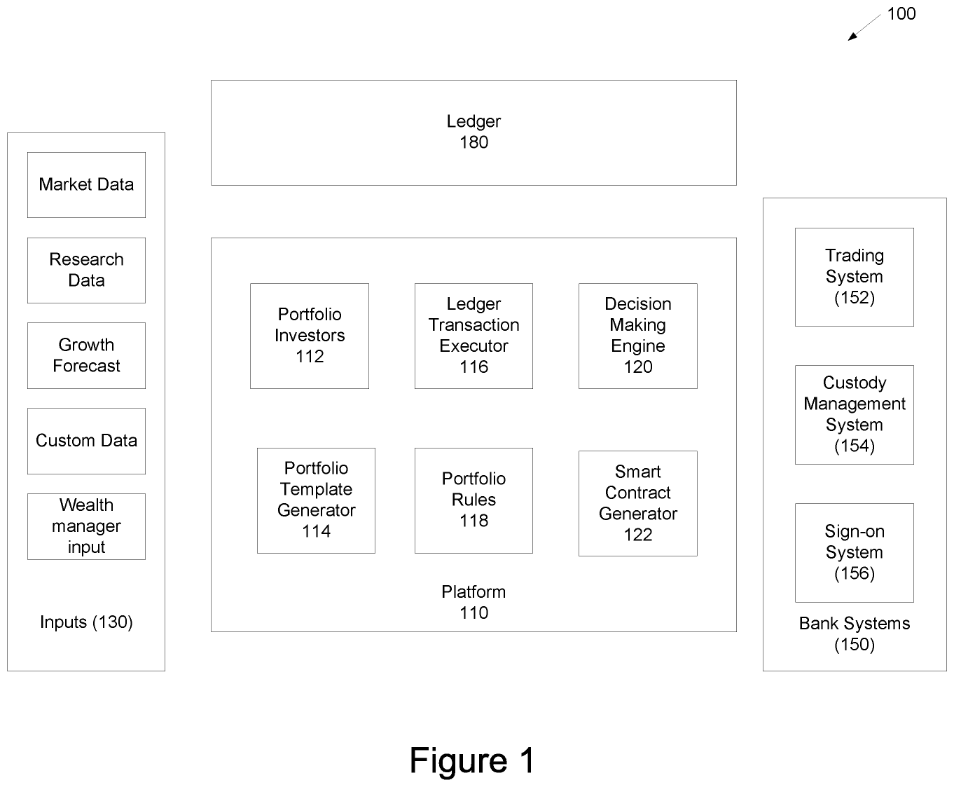

Several embodiments of the present invention and their advantages may be understood by referring to FIGS. 1-5.

Embodiments are directed to system and method for autonomous portfolio management and funding that allows an investor to leverage a self-managed autonomous platform using smart contracts.

In one embodiment, a bank or other financial institute may create a portfolio template with specific investment goals, such as return on investment (ROI), risk exposure, an industry sector to focus on, etc. The system may then generate a smart contract that will specify one or more execution rule, and may associate the smart contract with one or more portfolio. Examples of rules include sell rules (e.g., if the company/instrument credit rating is downgraded by a reputed firm by X, then sell the position), investment rules (e.g., if X company has signed a long-term deal with government, invest Y %; if X political party wins the election, increase investment in infrastructure companies by Y % as one of the primary agenda of that party is infrastructure reforms), etc. The variables (e.g., the X and Y) may be defined in any suitable manner. For example, a sponsoring financial institution may specify the details for the rules, the investors may specify the rules individually or through voting, etc.

In one embodiment, investors that are aligned to the goals of a specific portfolio may invest in the portfolio. Based on the investments, investors may receive voting rights to determine the bases for the execution of any rules.

In one embodiment, the system may also permit an individual investor to create the portfolio management by defining its own rules through smart contract. The investor may then use the customized portfolio exclusively, or may invite other investors. If the portfolio is only used by the investor, the investor will maintain all voting rights to direct the decision making. Where there are multiple investors, the decision making may be spread among the investors equally, in proportion to each investor's investments, or as otherwise desired.

In one embodiment, the bank or other financial institution may charge a fee (e.g., a per investor fee, a percentage of investment, etc.) for the platform from some or all the users. The bank or financial institution may also choose to publish the platform for free but may generate income through trading fees.

In one embodiment, investors may benefit from the input of others, as it is generally accepted that a crowd is wiser than one individual. Thus, if multiple investors with the same financial goals make the same decision, the probability that it is the correct decision will be higher.

Once rules are created, they may be executed through a smart contract that ensures its trustworthiness. Smart contracts also provide transparency with regard to the rules that govern the portfolio. They may eliminate, or significantly reduce, any uncertainty on how the portfolio will behave in a given market condition, environment, or occurrence. They may also allow an investor to exit the portfolio if the investor is not comfortable with (or does not agree with) the possibility that certain rules may be executed in the near future.

Embodiments may significantly reduce the operating cost of the portfolio management as most of the decisions are made and executed by smart contracts.

Referring to FIG. 1, a system for autonomous portfolio management and funding using smart contracts is disclosed according to one embodiment, System 100 may include inputs 130, platform 110, bank system 150, and ledger 180. Inputs may include any suitable input that may be relevant to an investment, including, for example, market data, research data, growth forecasts, custom data, wealth manager input, etc. Other input data may include weather forecast, news and political developments, mergers and acquisitions, business news, etc.

In one embodiment, input(s) 130 may interface with platform 110. For example, input(s) 130 may be provided to decision engine 120, which may determine if any action(s) should be taken.

Bank systems 150 may include any necessary system that may be involved in a transaction or trade, such as trading system 152, custody management system 154, and sign-on system 156.

In one embodiment, sign-on system 154 may provide access to one or more investor account including accounts that may be external to the financial institution. In one embodiment, the account(s) may fund the portfolio.

In one embodiment, bank systems 150 may interface with platform 110 and may execute any instructions as instructed by platform 110.

Platform 110 may include various modules that allow the user to create an on-demand portfolio backed by a smart contract. A portfolio may specify the various external dependencies that are used to generate the rules for the smart contract. Based on the rules, platform 110 will buy or sell the stocks from the portfolio using bank systems 150.

In one embodiment, the modules may include portfolio investors 112, portfolio template generator 114, ledger transaction executor 116, portfolio rules 118, decision making engine 120, and smart contract generator 122.

Portfolio template generator 114 may generate a specific portfolio template that is aligned to goals, such as user goals, investor goals, etc.

Portfolio rules 118 may allow the user(s) or investor(s) to define the rule(s) that are associated with a given portfolio. The rule(s) may govern how the portfolio will react to the various market events.

Portfolio investors 112 may contain the details of the investor(s) and/or users associated with a given portfolio.

Smart contract generator 122 may contain the logic for generating one or more smart contract based on portfolio rules 118 for a given portfolio.

Decision making engine 120 may make decisions based on, for example, user voting. In one embodiment, decision making engine 120 may leverage decentralized autonomous organization decision making using, for example, the rules embedded in smart contracts.

Ledger transaction executor 116 may commit smart contracts, transactions, relevant events (e.g., events that are may trigger a rule), etc. to ledger 180. In one embodiment, ledger 180 may be a dependent ledger, such as a Blockchain-based ledger. Ledger 180 may provide transparency to all users, investors, etc.

In one embodiment, platform 110 may comprise one or more servers, computer processors, etc. Each component may be executed by one server or computer processor; alternatively, a component may be executed by a separate computer processor. Any suitable execution environment may be provided as necessary and/or desired.

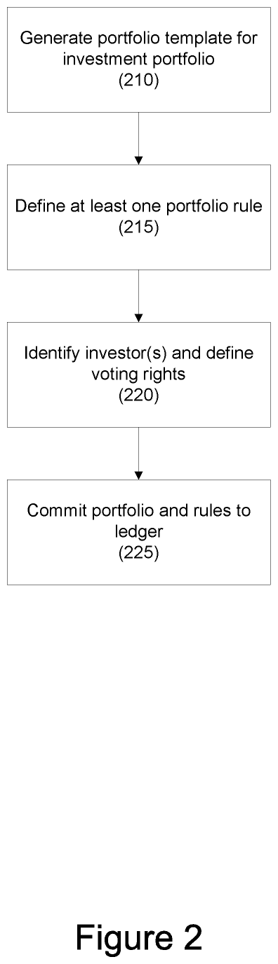

Referring to FIG. 2, a method of autonomous portfolio management and funding is disclosed according to one embodiment. In step 210, a portfolio template for an investment portfolio may be generated. In one embodiment, the portfolio template may be specified by a bank or other financial institute. In another embodiment, the portfolio template may be specified by an individual, such as an investor. The portfolio template may comprise specific investment goals, such as return on investment (ROI), risk exposure, sector to focus on, etc.

In step 215, one or more portfolio rule(s) may be defined. For example, the rule(s) may specific execution rules in response to an event, such as a market event, a political event, a weather event, etc. Example rules include sell rules, investment rules, reallocation rules, etc.

In one embodiment, the rules may specify a change in a portfolio allocation by triggering trading systems. The rules may also specify the use of a currency that may be available on the ledger (e.g., a crypto-currency) to conduct the transaction.

In one embodiment, the rule(s) may be identified during the generation of the portfolio template; in another embodiment, investor(s) may specify the rules and may vote on parameters for the rule(s). Other suitable ways of specifying portfolio rules may be used as is necessary and/or desired.

In step 220, investors for the portfolio may be identified. In one embodiment, the investors may be identified by the portfolio template being made available to potential investors, and the potential investors deciding to invest.

In one embodiment, investor voting rights may be defined. In one embodiment, the lead investor (that may also be the entity that specified the portfolio template) may have sole voting rights. In another embodiment, each investor may have voting rights. The voting rights may be equally distributed among all investors, or they may be based on the amount of each investor's investment, etc. Any suitable manner of determining voting rights may be used as necessary and/or desired.

In step 225, the portfolio template, rules, and/or investors may be committed to a dependent ledger, such as a Blockchain ledger.

In one embodiment, the portfolio template, rules, and/or investors may be committed to the ledger as a smart contract.

In one embodiment, the portfolio manager and/or investors may define or specify the rule(s) using any suitable interface, including a graphical user interface, a command line interface, a web-based interface, mobile applications, etc.

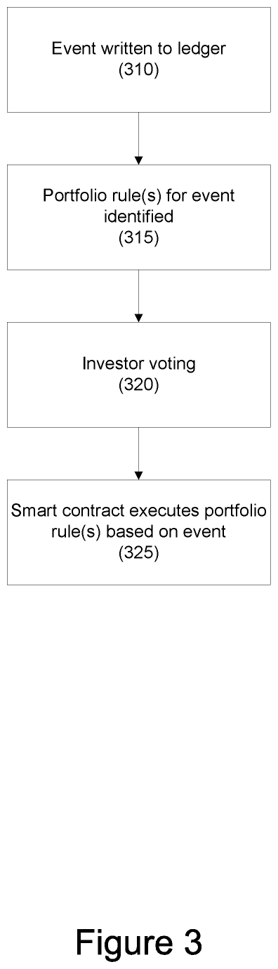

Referring to FIG. 3, a method of autonomous portfolio management and funding is disclosed according to one embodiment.

In step 310, an event may occur, and that event may be written to the ledger. For example, a political event may occur, a weather event may occur, a market event may occur, etc. In one embodiment, the event may be automatically written to the ledger by an external system, by a system monitoring the market, the portfolio, individual investments in the portfolio, etc., news services, etc. In another embodiment, a wealth manager, financial advisor, investor, etc. may write the event to the ledger.

In one embodiment, the event may further include governmental data such as the employment rate, agricultural output purchasing power, changes in demographics, etc.

In step 315, a portfolio rule for the event may be identified. In one embodiment, the portfolio rule may have a threshold; thus, if the event does not meet the threshold, no action is taken.

In step 320, if a threshold is met, or the rule is otherwise activated, investor voting may be required. In one embodiment, this may be based on the portfolio rules. If investor voting is required, the investors may be polled for their votes as necessary and/or required, and their responses may be given the appropriate weighting.

In one embodiment, voting may be performed electronically.

In step 325, the smart contract may execute the portfolio rule based on the voting (if necessary). In one embodiment, the smart contract may direct one or more external systems to take one or more action with regard to the portfolio.

In one embodiment, the portfolio may be funded using smart contracts, and a single sign-on may be provided to access one or more investor accounts that may fund the portfolio.

In one embodiment, a computer application or banking system may provide single sign-on so that a customer, etc. may access multiple accounts (e.g., deposit, checking, savings, credit, mortgage, etc.) with different financial institutions, etc. For example, a customer may enter data for their accounts, and may provide instructions to credit or debit any of these accounts using via this application or system. For example, in one embodiment, a user may register one or more account(s) with the application, and the application may request authentication from the financial institutions hosting the accounts. The application may execute a “Key Exchange” with the financial institution for authentic routing of transactions.

In one embodiment, the accounts may be held by the same or different individuals or entities (e.g., corporations, partnerships, LLCs, etc.). A single command may debit one or more of the accounts simultaneously.

As another example, a portfolio manager may access one or more investor accounts to fund a portfolio. For example, each investor investing in a portfolio may give permission to the portfolio manager to access an account, even if from multiple financial institutions. If a smart contact that requires funding for a portfolio is executed, the smart contract may further access the accounts and may withdraw or deposit funds as necessary.

In one embodiment, the smart contract may perform this access using a single application.

In one embodiment, transactions may be written to a ledger, such as a dependent ledger. In one embodiment, the ledger may be centralized; in another embodiment, the ledger may be distributed so that each financial institution that supports the application may maintain a copy of the ledger.

Examples of such a distributed ledger is disclosed in U.S. patent application Ser. No. 15/233,719 and 15/234,263, the disclosures of which are hereby incorporated, by reference, in their entireties.

In one embodiment, the application may store personal information, such as a social security number, account numbers, PINs, biometrics, etc. Security mechanisms may be provided to ensure the security of this data.

In one embodiment, the user (e.g., customer, investor, portfolio manager, etc.). may be authenticated in any suitable manner, such as biometric authentication, out-of-band authentication, etc. In one embodiment, the degree of authentication required may depend on the value of the transaction, the risk involved with the transaction, etc.

In one embodiment, transaction limits (e.g., a transaction amount limit, number of transaction limits, etc.) may be used as a security feature.

In one embodiment, the transactions may be insured by an insurer (e.g., a third party insurance provider) to insure the transaction in the event of fraud.

In one embodiment, several insurers may be associated with, or tied to, the transaction and/or application to give an option for one-time payment clients. In one embodiment, this may serve as a point of revenue for the hosting financial institution.

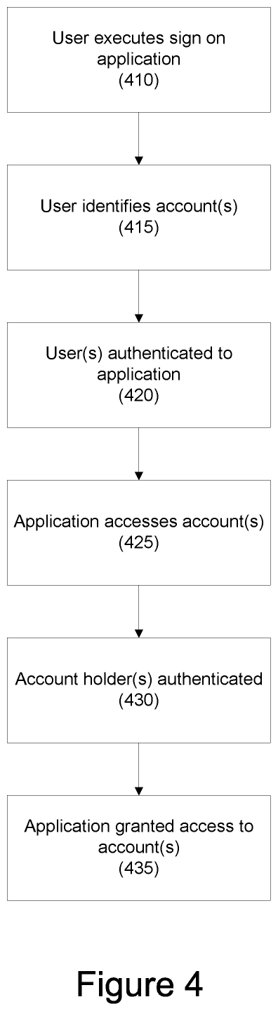

Referring to FIG. 4, a method for conducting a sign-on transaction is disclosed according to one embodiment.

In step 410, a user (e.g., a customer, an investor, a portfolio manager, a smart contract, etc.) may launch an application or computer program that may be executed by a computer processor on an electronic device, such as a mobile device, a workstation, a desktop computer, a notebook computer, a tablet computer, an Internet of Things appliance, etc.

In one embodiment, the application may be hosted or provided by a financial institution, a third party, an aggregator, etc. In one embodiment, if the user is a smart contract, the same system that executes the smart contract may execute the application. In another embodiment, a different system may execute the application.

In step 415, the user may identify accounts with a plurality of financial institutions. In one embodiment, the user may provide usernames for online account access. In one embodiment, the user may provide the user's password, a temporary password, a limited use password, etc. In another embodiment, the user may not provide a password.

In one embodiment, the portfolio manager may provide the accounts to the application. In another embodiment, a smart contract may retrieve account numbers from investors.

In step 420, the user may provide authentication information, such as the password, out-of-band authentication, biometric data, etc. Any suitable authentication may be used as necessary and/or desired.

In step 425, the application may interface with each financial institution to gain access to the accounts. In one embodiment, the financial institution may provide account credentials, a token, etc. to each respective financial institution. The application may provide any other authentication information as is necessary and/or desired.

In step 430, the financial institution may verify the authenticity of the request with the account holder(s). In one embodiment, the financial institution may do this using the financial institution's application, by in-person confirmation, by out-of-band confirmation, etc.

In step 435, once verified, the financial institution may permit the application to have access to the user's account. In one embodiment, the financial institution may provide the application with a cookie, token, or other suitable identifier. This may be used to authenticate the user for future accesses.

In one embodiment, the approval to access the account may be terminated by the smart contract, when the portfolio ceases to exist, etc.

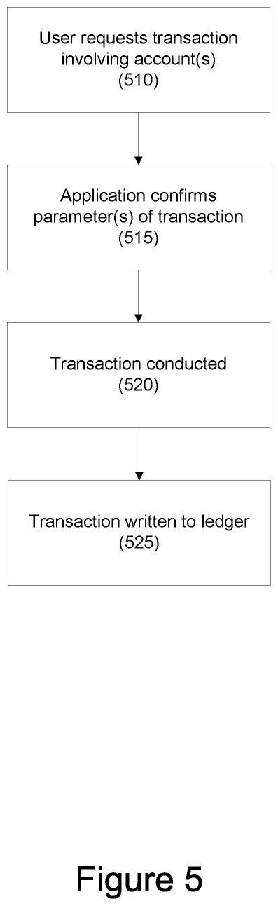

Referring to FIG. 5, a method for the application to conduct a transaction is disclosed according to one embodiment.

In step 510, the user (e.g., customer, investor, portfolio manager, smart contract, etc.) may request a transaction involving one or more account.

In step 515, the application may confirm the parameters of the transaction. For example, the application may confirm that the amount of the transaction is not above a certain amount, that the number of transactions involving the account is not above a certain number, that the user has provided sufficient authentication based on the transaction amount and/or risk associated with the transaction, etc.

In one embodiment, if the transaction is being conducted by a third party user (e.g., a fund manager, smart contract, etc.), the application may seek approval from the account holder by, for example, out-of-band approval, etc.

In step 520, the transaction may be executed and, in step 525, the transaction may be committed to a ledger, such as a Blockchain ledger. In one embodiment, each financial institution may receive notifications based on the transaction being committed to the ledger.

In one embodiment, the ledger may be distributed, and each financial institution may maintain its own copy of the ledger. When the transaction is conducted, each financial institution may reconcile its ledger based on the transaction. In another embodiment, only the financial institutions participating in the transaction may reconcile their ledgers.

In one embodiment, the security measures used to approve a transaction may be commercialized.

Although several embodiments have been disclosed, it should be recognized that these embodiments are not exclusive to each other.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for autonomous portfolio management comprising:
configuring, for a portfolio management system, a plurality of external data inputs comprising market and research data, and an internal input comprising an outcome of a weighed voting process polled from one or more investors and weighed according to one or more respective investments amounts;
generating, using a computer processor, a portfolio template for an investment portfolio, the portfolio template comprising at least one investment vehicle, an identification of one or more investors, an identification of at least one funding account associated with each of the one or more investors, an identification of an investment goal, and a plurality of portfolio rules each of which specifies a condition associated with one or more external data inputs, from the plurality of external data inputs, exceeding a predetermined threshold value, and an action to take with the investment vehicle in response to the condition;
system determining, based on the plurality of external data inputs, the occurrence of the condition associated with a portfolio rules from the plurality of portfolio rules;
writing the occurrence of the condition, using a smart contract, to a distributed ledger and initiating the weighted voting process; and
executing, based on the outcome of the weighted voting process, the smart contract comprising executing the action, associated with the portfolio rule from the plurality of portfolio rules, wherein the action includes accessing a funding account based on a token associated with at least one investor, wherein the token is configured to authenticate an access to the funding account;

2. (canceled)

3. (canceled)

4. The method of claim 1, further comprising:
the portfolio management system monitoring at least one environment for the condition; and
the portfolio management system writing the condition that was monitored to the ledger.

5. The method of claim 4, wherein the environment is an economic environment.

6. The method of claim 4, wherein the environment is a political environment.

7. The method of claim 1, wherein the action is a funding action for funding the portfolio.

8. The method of claim 7, wherein the portfolio template further comprises sign-on information for the funding account, and the method further comprises:
the portfolio management system accessing the funding account using the sign-on information; and
the portfolio management system transferring funds from the funding account to the portfolio;
the portfolio management system writing the transfer of funds to the distributed ledger.

9. The method of claim 8, wherein the sign-on information is associated with a plurality of funding accounts.

10. The method of claim 1, wherein executing the action comprises:
the portfolio management system executing a trade involving the investment vehicle.

11-19. (canceled)
